(19) United States
(12) Patent Application Publication
(10) Pub. No.: US 2004/0199660 A1
(43) Pub. Date: Oct. 7, 2004

(54) Method of multiplexing compressed and uncompressed internet protocol packets

(75) Inventor: Zhigang Liu, Irving, TX (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/369,211

(22) Filed: Feb. 14, 2003

(51) Int. Cl. G06F 15/16

(52) U.S. Cl. 709/236

(57) ABSTRACT

A method and device for multiplexing a stream of packets containing uncompressed and compressed packets. In a compressed packet, an identification bit pattern is inserted between the compressed payload data and the transport header so that a decompressor can determine whether the packet is compressed based on the presence of the identification bit pattern. Because the compressed packet carries the original transport header of a packet with minor modification, an intermediate node on the path of packet can see information in the transport header. In contrast, the transport header in an IPComp packet is part of IP payload and thus compressed.

### FIELD OF THE INVENTION

The present invention relates generally to payload data carried in Internet Protocol (IP) packets and, more particularly, to compression of the payload data.

### BACKGROUND OF THE INVENTION

IP payload compression is used to reduce the size of IP datagram in order to increase the overall communication performance between a pair of communicating nodes. It reduces data throughput and thus saves bandwidth, especially over bandwidth-limited links such as radio links. IP compression is particularly important in cellular systems such as 3GPP. When applying compression to payload data carried in TCP/IP (Transmission Control Protocol/Internet Protocol) or UDP/IP (User Datagram Protocol/Internet Protocol) packet streams, it is likely that the compressor has to send to its peer decompressor packets with compressed payload and packets with uncompressed payload. The compressor is used to send uncompressed payload for at least two reasons: 1) The original packet is incompressible because the packet is encrypted or the packet contains data that is already compressed (e.g. images), and 2) Synchronicity over compression context between compressor and decompressor has been lost and the compressor must send uncompressed packets until the context synchronization is re-established. Furthermore, where there are not enough resources to compress every packet, compression can only be applied to a portion of the packet stream. As a result, there can be a mixture of compressed packets and uncompressed packets within the same packet flow from a compressor to its peer decompressor. Therefore, a certain multiplexing mechanism is needed so that the decompressor can distinguish between a compressed packet and an uncompressed packet. A block diagram illustrating the packet flow between a compressor and a decompressor is shown in FIG. 1.

Currently, IPComp (IP Payload Compression Protocol) is used for IP payload compression. IPComp is a standardized protocol by the Internet Engineering Task Force (IETF). It specifies that the original header should be modified to indicate the use of IPComp protocol. In order for a receiver to identify whether the packet is compressed, a code or protocol number is provided in the header. The header of Internet Protocol version 4 (IPv4) is shown in FIG. 2, and that of Internet Protocol version 6 (IPv6) is shown in FIG. 3. In particular, the Protocol field of an IPv4 header or the Next Header field in an IPv6 header is changed to the code “108” to indicate that the IP payload data in the packet is in a compressed form. The original value of the field is then stored in an IPComp header, which is inserted immediately preceding the compressed payload but after the modified IP header.

Packet compression, in general, can be performed on a packet-by-packet basis (stateless compression) where no history or state information across packets is provided, or performed in an inter-packet fashion (stateful compression) where compression history is retained across multiple IP datagrams. Currently, IPComp can only be used for stateless compression, and not stateful compression. It is thus advantageous and desirable to provide a method and device which can be used in stateful or stateless compression.

### SUMMARY OF THE INVENTION

The present invention uses in-band indication to distinguish between compressed and uncompressed transport protocol packets. The in-band indication is carried out in a form of bit pattern in the payload part of a compressed packet.

Accordingly, the first aspect of the present invention is a method of multiplexing a stream of packets for conveying payload data from a first network component to a second network component, the stream of packets including at least one compressed packet comprising a header segment and a data segment following the header segment, wherein the data segment is used to carry at least a portion of the payload data, and the header segment of said packet contains information indicative of an identity of the second network component. The method is characterized by

partitioning the data segment of said compressed packet into a first section and a second section, by

providing said portion of the payload data in a compressed form in the first section, and by

providing further information in the second section, the further information indicating that said portion of the payload data is in the compressed form, wherein the second section of said compressed packet is located between the first section and the header segment of said compressed packet.

Advantageously, an optical error check code, such a cyclic redundancy check code, is provided in the second section for detecting transmission errors in the compressed packet.

Preferably, the further information is provided in a predetermined bit pattern, known to the second network component.

According to the second aspect of the present invention, there is provided a compression algorithm to be used in a first network component capable of conveying a stream of packets containing payload data to a second network component, the stream of packets including at least one compressed packet comprising a header segment and a data segment following the header segment, wherein the data segment is used to include at least a portion of the payload data, and the header segment of said packet contains information indicative of an identity of the second network component. The compression algorithm is characterized by

compressing the portion of the payload data for providing compressed data;

providing the compressed data in a first segment of the data segment of the compressed packet; and

providing further information in a second segment of the data segment of the compressed packet, wherein the further information indicating that the portion of payload data is compressed, and wherein the second section is located between the first section and the header segment of the compressed packet.

The algorithm is further characterized by

providing an error check code in the second section for detecting transmission errors in the compressed packet, and

determining whether the portion of the payload data is compressible so that said compression is carried out only if the payload data is compressible.

According to the third aspect of the present invention, there is provided a decompression algorithm to be used in a network component capable of receiving a stream of packets containing payload data conveyed from another network component, each of the packet containing a header segment and a data segment following the header segment, wherein the data segment is used to include at least a portion of the payload data, and the header segment of said packet contains information indicative of an identity of the second network component. The decompression algorithm is characterized by

determining whether the data segment contains further information indicating that the portion of the payload data is compressed; and

decompressed the portion of the payload data based on said determining.

According to the fourth aspect of the present invention, there is provided a network component adapted to transmitting and receiving a stream of packets containing payload data to a second network component, the stream of packets including at least one compressed packet comprising a header segment and a data segment following the header segment, wherein the data segment is used to include at least a portion of the payload data, and the header segment of said packet contains identity information indicative of an identity of the second network component. The network component is characterized by

a compressor capable of compressing the portion of the payload data for transmission; and

a decompressor capable decompressing the portion of the payload data in a received stream, wherein

the compressor is adapted to

compressing the portion of the payload data for providing compressed data,

providing the compressed data in a first segment of the data segment of the compressed packet; and

inserting information in a second segment of the data segment of the compressed packet, wherein the information indicating that the portion of payload data is compressed, and wherein the second section is located between the first section and the header segment of the compressed packet, and wherein the decompressor is adapted to

determining whether the data segment contains further information indicating that the portion of the payload data is compressed; and

decompressing the portion of the payload data based on said determining.

Advantageously, the network component includes a mobile terminal capable of uplink and downlink communications in a telecommunications network, wherein the compressor and the compressor are disposed in the mobile terminal, such that

the compressor compresses the portion of the payload data, providing the compressed data in the data segment and inserting the information when the mobile terminal operates in uplink communications, and

the decompressor determines the further information and decompresses the portion of the payload data based on said determining when the mobile terminal operates in downlink communications.

According to the fifth aspect of the present invention, there is provided a system for compressing and decompressing payload data in a stream of packets conveyed between network components in a communication network, the stream including at least one compressed packet comprising a header segment and a data segment following the header segment, wherein the data segment is used to include at least a portion of the payload data, and the header segment of said packet contains identity information indicative of an identity of a receiving network component. The system is characterized by

a compressor capable of compressing the portion of the payload data; and

a decompressor capable decompressing the portion of the payload data, wherein the compressor is adapted to

compressing the portion of the payload data for providing compressed data,

providing the compressed data in a first segment of the data segment of the compressed packet; and

inserting information in a second segment of the data segment of the compressed packet, indicating that the portion of payload data is compressed, and wherein the second section is located between the first section and the header segment of the compressed packet, and wherein the decompressor is adapted to

determining whether the data segment contains further information indicating that the portion of the payload data is compressed; and

decompressing the portion of the payload data based on said determining.

The present invention will become apparent upon reading the description taken in conjunction with FIGS. 5 to 8.

### BRIEF DESCRIPTION OF THE DRAWINGS

FIG. 1 is a block diagram illustrating part of a typical network comprising a payload data compressor and decompressor.

FIG. 2 shows a header format according to Internet Protocol version 4.

FIG. 3 shows a header format according to Internet Protocol version 6.

FIG. 4 shows an uncompressed packet.

FIG. 5 shows a compressed packet, according to the present invention.

FIG. 6 is a flowchart illustrating the method of generating a compressed packet, according to the present invention.

FIG. 7 is a block diagram illustrating the payload compressor and decompressor capable of carrying out the present invention.

FIG. 8 is schematic representation illustrating a telecommunication network.

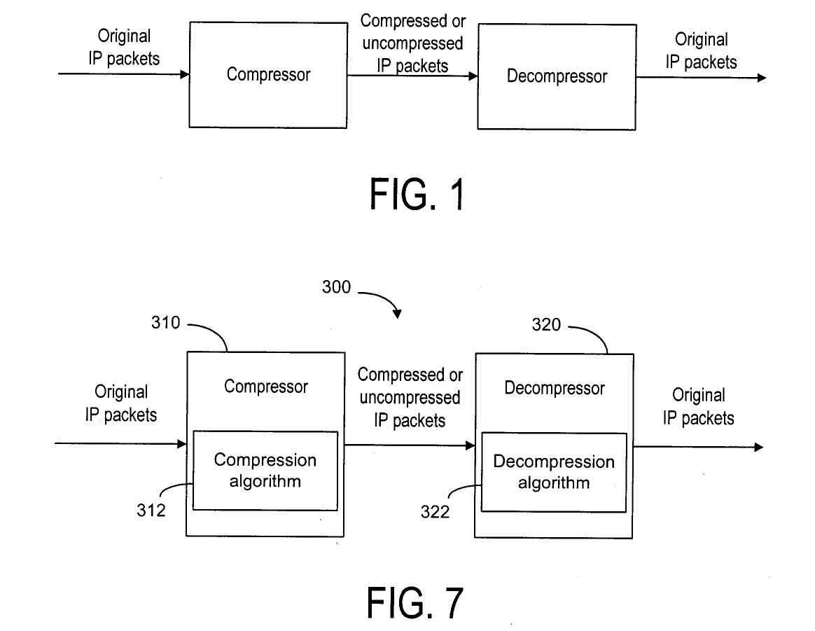

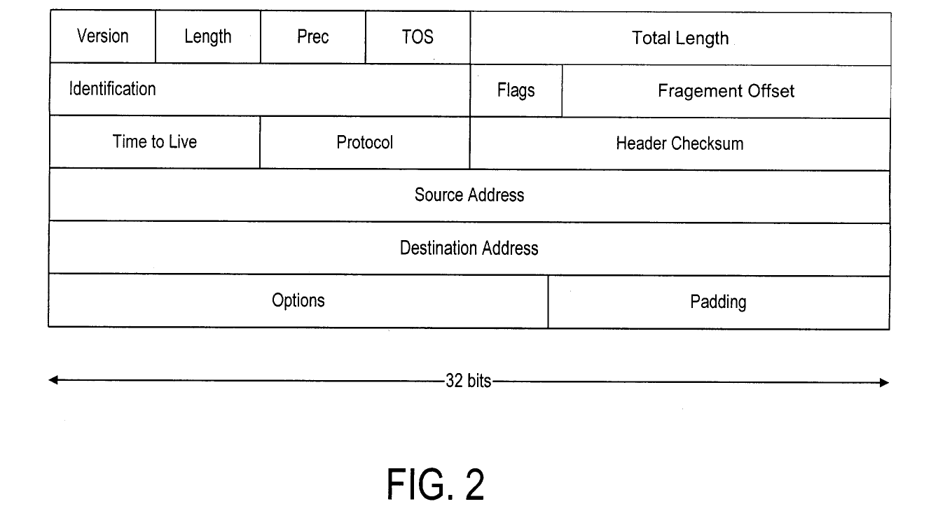

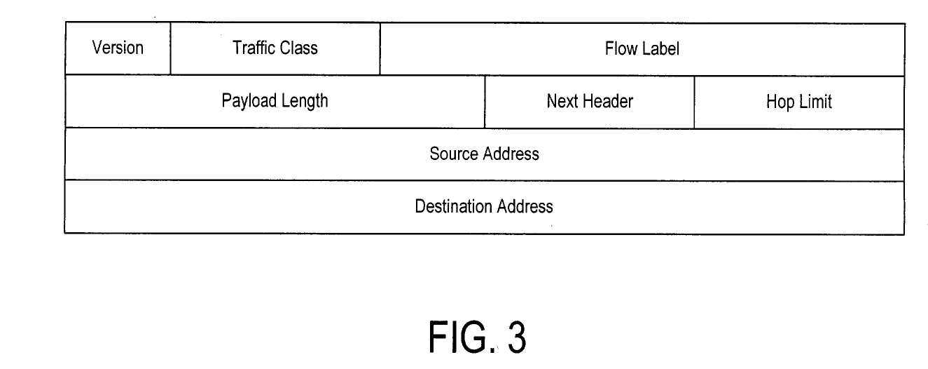

### BEST MODE TO CARRY OUT THE INVENTION

The present invention uses in-band indication to distinguish between compressed and uncompressed TCP/IP or UDP/IP packets. The term “in-band” refers to the fact that the indication is carried in the payload part of a compressed packet, and “payload” refers to the data carried in a packet after the IP and transport header. According to the present invention, the compressed payload does not include the transport header. In contrast, the transport header in IPComp is considered as part of the payload and compressed.

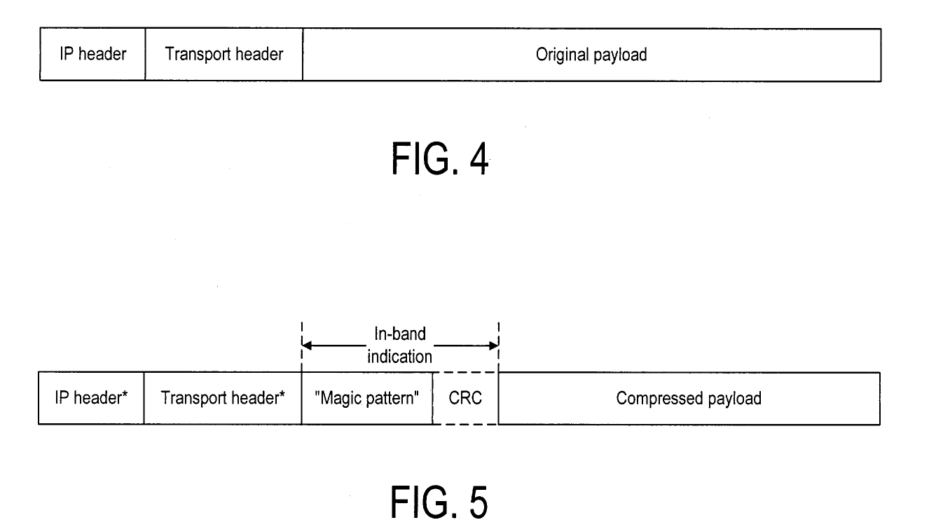

According to the present invention, when a compressor encounters an incompressible packet in a stream of packets, it sends the original packet along the flow without modification, as shown in FIG. 4. Otherwise the compressor compresses the payload carried in the packet after transport header and inserts an in-band indication immediately preceding the compressed payload but after the transport header. The in-band indication consists of a predetermined indication pattern, or “magic pattern” and, optionally, a CRC (cyclic redundancy check, a checksum) that is calculated over the compressed packet, as shown in FIG. 5. Both the “magic pattern” and the polynomial of the CRC (if enabled) must be agreed upon in advance between the compressor and the decompressor. As such, the decompressor identifies a compressed packet by detecting the presence of the in-band indication. If a packet does not carry such an in-band indication, the decompressor assumes the packet is uncompressed.

Parameters

The following parameters are used to describe the compressor logic and in exemplary pseudo code for implementing the present invention for various Internet related protocols.

max_len=maximum payload length, as constrained by the MTU (Maximum Transmission Unit) of the link immediately after compressor (i.e. over which the compressor sends packets)

orig_len=length of the original payload received by compressor

comp_len=length of the compressed payload

m1=length of the “magic pattern”, with m1>=1. m1 is an implementation parameter.

m2=length of the CRC, with m2>=0. m2 is an implementation parameter.

m=m1+m2

t=the threshold (of size reduction) used by compressor to determine if a compressed packet should be sent or not. Here t is an implementation parameter, which must be equal to or greater than m in order to guarantee non-expansion policy

Compressor Logic

In the following text, transport protocol refers to transport layer protocol above IP, such as (but not limited to) UDP, TCP, and SCTP. Transport checksum refers to the checksum field in a transport protocol header.

Step 1. If received packet is IPv4, verify IPv4 header checksum, and then the transport checksum. If it is an IPv6 packet, only transport checksum needs to be verified since IPv6 header has no checksum field.

If either checksum fails the test, discard the packet and stop. (The packet is already corrupted and will be discarded by the decompressor and the end receiver anyway.)

Else, continue to the next step.

Step 2. Compress the payload carried in the packet after the transport header. The result is comp_len.

Step 3. If comp_len>=min (max_len, orig_len)−t, send the original packet and stop.

Else, continue to the next step.

Step 4. Construct a compressed packet according to the format shown in FIG. 5.

Step 5. Modify IP header and transport header if necessary. In particular:

If it is IPv4, set the “Total Length” field in IPv4 header to the total length of the compressed packet including the IPv4 header. In addition, recalculate the “Header Checksum” field.

If it is IPv6, set the “Payload Length” field to the length of data after the IPv6 header in the compressed packet. Note: any present extension headers are included in the length count.

If the transport protocol is UDP, set the “Length” field in UDP header to the total length of UDP header, magic pattern, CRC, and compressed payload.

If the transport protocol is SCTP (Stream Control Transmission Protocol), there is no packet length field in the common header. No special treatment is needed since the length of compressed packet can be derived from IP header.

For other transport protocol header, update length field (if present) accordingly.

Special note: DO NOT modify checksum field in any of above transport protocol headers (such as UDP, TCP, SCTP, or any other transport protocols.)

Step 6. Calculate the CRC if enabled. The CRC should cover the entire compressed packet. For purpose of CRC calculation, the CRC field itself is initialized to zero before the calculation.

Step 7. Send the compressed packet.

Note: Step 3 in the compression logic is designed to enforce the non-expansion policy as well as to avoid fragmentation (see fragmentation issues below). Although it is sufficient to have a size reduction threshold t that equals the size of in-band indication, the compressor may set t to a larger value. For example, if a compressed packet is only a few bytes smaller than the original one, it may not worth to send the compressed packet that will incur processing cost on the decompressor side. In addition, the compressor may decide not to send a compressed packet—even though it is allowed to do so by the rule in Step 3—for reasons beyond the scope of the present invention.

Decompressor Logic upon Receiving a Packet

Step 1. If received packet is IPv4, verify IPv4 header checksum.

If it fails the test, IPv4 header is corrupted, discard the packet and stop.

Else, continue to the next step.

Step 2. Check to see whether the beginning of the received payload matches the “magic pattern”.

If the beginning of the received payload does not match the “magic patter”, deliver the packet by assuming the packet is uncompressed and then stop.

Else, continue to the next step.

Step 3 (skip this step if CRC is not enabled). Calculate the CRC assuming the received packet is compressed (see Step 6 in the compression logic). Then compare it with bits in the received packet that immediately follow the “magic pattern”.

If they do not match, the packet is uncompressed, deliver it and stop.

Else, continue to the next step.

Step 4. Extract the compressed payload and decompress it. Then, reconstruct the original packet, including regenerating the original value of IP and transport header fields that have been modified by compressor (see Step 5 in the compression logic).

Note: except the rare case of collision, the packet must be compressed when the calculated CRC matches with bits immediately following the “magic pattern”.

Step 5. Verify the decompressed packet against the transport checksum, which was NOT modified by the compressor.

If the decompressed packet passes the test, decompression succeeds, deliver the decompressed packet and stop.

Else, continue to the next step.

Step 6. (There could be various possible reasons that lead the decompressor to this step. One of them is the collision of in-band indication as mentioned previously. To determine if this is the case, the decompressor goes back to the received packet before decompression and verifies the transport checksum).

If the packet passes the test, this is a collision and the received packet is actually uncompressed, deliver it and stop.

Else, continue to the next step.

Step 7. This is an erroneous state. Discard the received packet.

Note:

Steps 2 and 3 of the decompression logic—The decompressor may verify the uncompressed packet against the transport checksum before delivering the packet. This can detect transmission errors. However, it is an implementation issue.

Step 6—The decompressor may also need to roll back its context if it has been updated in Step 4. Whether this is needed and how it is done are compression algorithm dependent, and thus beyond the scope of the present invention.

Step 7—In the case that CRC is not enabled, the decompressor may end up in Step 7 if the received packet is indeed compressed but corrupted by transmission errors in either the compressed payload or the transport header.

Enabling CRC

The CRC in this invention serves two purposes: a) to detect transmission errors in a compressed packet, and b) to further reduce the probability of collision. Whether the CRC should be enabled depends on the compression algorithm that uses this invention.

For inter-packet (i.e. stateful) payload compression algorithms, it is strongly recommended to enable the CRC for purpose (a). That is because transmission errors in a compressed packet may corrupt the decompressor context, which will in turn cause decompression failure of subsequent compressed packets. This is often referred to as error propagation.

For per-packet (i.e. stateless) compression algorithms, error propagation is not an issue. Therefore, the CRC field is less important. For purpose (a), the correct decompression can be verified by the transport checksum anyway. As to purpose (b), the probability of in-band indication collision can be reduced exponentially by increasing the size of “magic pattern” alone. Hence, if the CRC calculation is considered undesirable due to processing cost, one may choose not to enable the CRC in the case of stateless compression.

Byte Alignment

“Magic pattern” and CRC field are not necessarily byte aligned. Moreover, the compressed payload may not be byte aligned either. Therefore, the payload part of a compressed packet (i.e. “magic pattern”+CRC+compressed payload) may not always be byte aligned. The compressor and decompressor must agree on the padding scheme (e.g. padding at the end of a compressed packet with bits of zeros). CRC calculation should then include the padding bits.

Magic Pattern

This predetermined identification pattern should be chosen carefully so that it does not coincide with a pattern that may appear regularly at the beginning of payload in the original packets.

Overhead of “Magic Pattern” and CRC Field

The probability of collision decreases exponentially (assuming random data) as the total length in-band indication (i.e. “magic pattern” and CRC) increases. Therefore, the scheme should work fine in practice with a small overhead, e.g. 16 to 24 bits. However, for an inter-packet compression algorithm, the CRC should not be counted as an overhead in this invention since it is needed anyway for the purpose of avoiding error propagation. In that case, the effective overhead for multiplexing purpose is only the “magic pattern”.

Bits Distribution between “Magic Pattern” and CRC Field

When CRC field is enabled, “magic pattern” should be long enough to reduce the probability that the decompressor performs CRC calculation (see Step 3 in the decompression logic) simply because of collision on “magic pattern” field alone. In practice, a magic pattern with size between 8 bits and 16 bits should work fine. Assuming random input, they correspond to collision probability of 1/256 and 1/65536, respectively. Thus, a much larger “magic patterns” is not necessary in general. The additional savings of CRC calculation (for packets mimicking “magic pattern” alone) is not worth the extra overhead on the wire.

Fragmentation Issue for IPv4

The method, according to the present invention, guarantees no IP fragmentation of compressed IPv4 packets on the link immediately after the compressor (referred to as “out-link”). However, in the case that compressor and decompressor are separated by more than one link, it is possible that links farther away from compressor may have smaller MTU than that of the “out-link”. In that case, compressed packets might be fragmented before reaching the decompressor. However, as generally true in any payload compression scheme, the decompressor should reassemble any fragmented IP datagram before decompression, as specified in IETF RFC 3173 “IP Payload Compression Protocol (IPComp)”. Alternatively, the compressor can avoid fragmentation by setting max_len value according to the path MTU. How the compressor discovers the path MTU is beyond the scope of the present invention. For example, it could use an approach as specified in IETF RFC 1981 or similar approaches.

Fragmentation Issue for IPv6

The scheme guarantees there will be no fragmentation of compressed packets due to the non-expansion policy.

Other Compression Related Signaling

After the in-band indication of a compressed packet, compressor may insert additional compression related signaling, such as indication of which compression algorithm is applied to the packet, values of parameters for a particular algorithm, etc. In addition, some of the information can also be coded into the “magic pattern”. For example, compressor may use one “magic pattern” to indicate a packet compressed using one algorithm, and another “magic pattern” for a packet compressed by another algorithm.

Header without a Checksum Covering Payload Data

In a transport protocol in which the header does not contain a checksum covering payload data, the method according to the present invention can be partially applied with some modifications. In particular, besides the “magic pattern” and optional CRC over the compressed packet, the compressor can insert—as part of the in-band indication in a compressed packet—a CRC_orig that is calculated over the original payload. Then, in Step 5 of the decompression, the decompressor can use the CRC_orig (instead of transport checksum) to verify whether a packet is indeed compressed. However, there is one critical caveat of this approach. That is, since CRC_orig can only be inserted in a compressed packet, the decompressor cannot have verification on an uncompressed packet. Specifically, if the test in Step 5 in the decompression fails, the decompressor has no way to distinguish between the following two cases: a) the received packet is a compressed packet but contains transmission errors; and b) the received packet is an uncompressed packet that mimics “magic pattern” and CRC of compressed packet (if present). How the decompressor handles this ambiguity is an implementation issue. To guarantee no additional packet loss due to compression, the decompressor probably has to blindly deliver the packet assuming it is case b) even though the probability of case a) may be higher than that of case b). Anyway, the transmission errors (either in compressed or uncompressed packets) should be handled by the application level CRC/checksum. Or the application does not care transmission errors at all.

An Exemplary Pseudo Code for TCP/IPv4

The following is an example of pseudo code implementing the present invention for TCP/IPv4. It uses some parameters defined in previous section. With some minor modifications, the same piece of pseudo code can be used for TCP/IPv6, UDP/IPv4, UDP/IPv6, SCTP/IPv4, SCTP/IPv6, etc.

Compressor:

```
verify IPv4 header checksum and TCP checksum in the packet to be
compressed;
if passed {
    compress the packet;
}
else { /* the packet is corrupted before compressor */
    discard the packet;
}
if comp_len >= min(max_len, orig_len) − t {
    send the original packet;
}
else {
    Total Length in IPv4 header <- length of compressed packet;
    Update Header Checksum in IPv4; /* due to new Total Length
/*
    /* note: TCP header, especially TCP checksum, is NOT
modified! */
    calculate CRC over the compressed packet;
    send (IPv4 header + TCP header + “magic pattern”+ CRC +
compressed payload);
}
```

Decompressor

```
verify IPv4 header checksum of received packet;
if failed { /* IPv4 header is corrupted between compressor and
decompressor */
    discard the packet;
}
if first m1 bits of received TCP payload match “magic pattern” {
    calculate CRC assuming it is a compressed packet;
    if the CRC matches the m2 bits in packet after “magic
pattern” {
        decompress;
        check decompressed packet against TCP checksum;
        if passed {
            send the decompressed packet;
        }
        else { /* possible collision, though very unlikely
*/
            check TCP checksum against received TCP packet before
decompression;
            if passed {
                send the received TCP packet;
            }
            else {
                discard the packet; /* abnormal errors */
            }
        }
    }
}
/* If we reach here, that means the packet is either uncompressed
or compressed but has transmission errors in “magic pattern” or
CRC field */
verify TCP checksum against received TCP packet;
if passed { /* it is uncompressed and not corrupted */
    send the received packet;
}
else { /* the packet is corrupted */
    discard the packet;
}
```

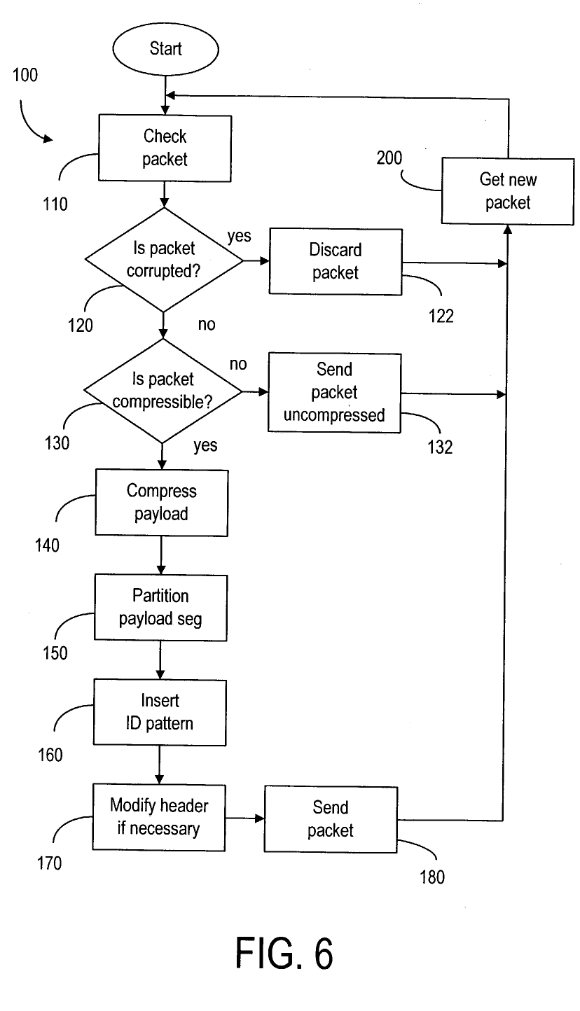

The method of multiplexing a stream of IP packets including compressed and uncompressed packets is illustrated in FIG. 6. As shown in the flowchart 100, after the compressor receives a packet at step 110, it determines whether the packet is corrupted at step 120. If the packet is unusable, then the packet is discarded at step 122 and a new packet is obtained at step 200. If the packet is not corrupted, then the compressor checks to see whether the payload data is compressible at step 130. If data is incompressible, the packet is send at step 132 without modification. Otherwise the payload is compressed at step 140 and the payload segment of the packet is partitioned into two sections at step 150. One section is for carrying the compressed payload, and the other is for inserting the “magic pattern” and an optional CRC at step 160. If necessary, the header of the packet is modified at step 170. The compressed packet is sent at step 180.

In order to carry out the multiplexing method, according to the present invention, the compressor and the decompressor must the necessary algorithms to process the packets. As shown in FIG. 7, a data network 300 comprises a compressor 310 and a decompressor 320. The compressor 310 comprises a compression algorithm 312 to compress IP packets and multiplex a stream of compressed and uncompressed packets. The compression algorithm 312 can be the exemplary TCP/IPv4 pseudo code for compression, or another similar code that follows the compressor logic as discussed above. The decompressor 320 comprises a decompression algorithm 322 to sort out the compressed packets from the packet stream and decompressed them accordingly. The decompression algorithm 322 can be the exemplary TCP/IPv4 pseudo code for decompression give above, or another code that follows the decompressor logic as discussed above.

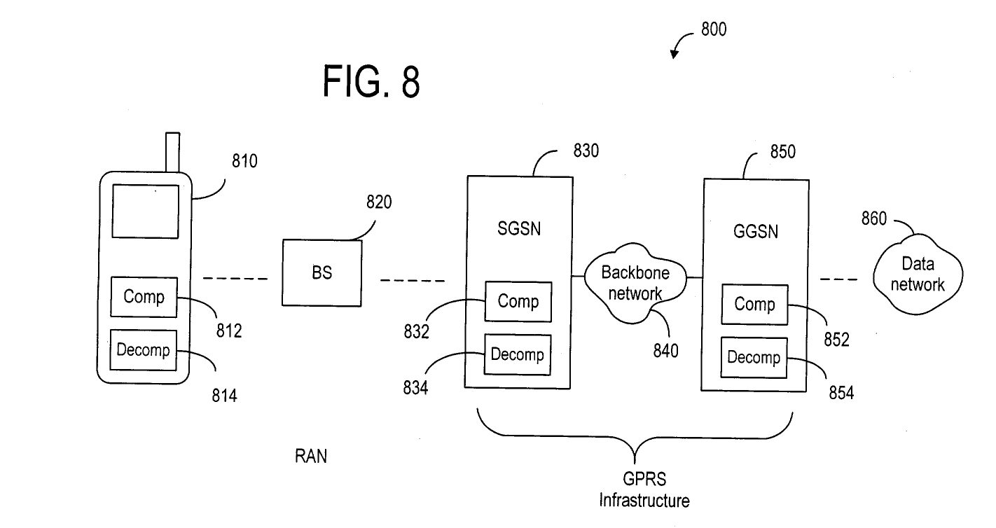

The present invention is useful when memory consumption in a device or the bandwidth in data transmission is critical. Thus, the compression method, according to the present invention, is useful in compressing payload data carried in TCP/IP, UDP/IP or SCTP/IP packets or the like. The compressor and decompressor depicted in FIG. 7 can be implemented in various components in a telecommunications network as shown in FIG. 8. As shown in FIG. 8, a GPRS (General Packet Radio Service) network 800 comprises a mobile terminal 810, a Base Station 820 in RAN (Radio Access Network), a SGSN (Serving GPRS Support Node) 830 and a GGSN (Gateway GPRS Support Node) 850 linked by a GPRS backbone network 840 in the GPRS Infrastructure to communicate with a Data Network 860. The mobile terminal 810 has a compressor 812 and a decompressor 814 to compress or decompress Internet data/messages. Likewise, the SGSN 830 has a compressor 832 and a decompressor 834 while the GGSN 850 has a compressor 852 and a decompressor 854. The compressors 812, 832 and 852 are similar to the compressor as described in conjunction with FIG. 7, using the methods as described in conjunction with FIGS. 5 and 6. The decompressors 814, 834 and 854 are similar to the decompressor as described in conjunction with FIG. 7. In the uplink when the mobile terminal 810 sends packets to a remote receiver, the involved components are the compressor 812, and either the decompressor 834 in the SGSN 830, or the decompressor 854 in the GGSN 850. In the downlink when the mobile terminal 810 receives packets from a remote site, the involved components are the decompressor 814, and either the compressor 832 in the SGSN 830, or the compressor 852 in the GGSN 850.

The present invention provides a simple and generic scheme to multiplex between compressed and uncompressed IP packets. It has following advantages over IPComp:

“Clear” Transport (e.g. TCP, UDP or SCTP) Header

In the present invention, a compressed packet carries the original transport header except some minor modifications. Therefore, an intermediate node on the path of the packet can still see important information (e.g. source and destination port number) regarding the packet. This makes it possible for the intermediate node to apply stream-based QoS control/optimization or security enforcement (e.g. in case of a firewall). In IPComp, this is not possible as transport header is part of IP payload and thus compressed.

Compatible with Link Layer Header Compression

As explained above, transport header is visible to intermediate mode and therefore can be compressed, e.g. by ROHC (Robust header compression) and RFC 2507. This is not possible in IPComp, where only the IP header can be compressed.

Independent of Compression Algorithms

The present invention can be used for either per-packet (i.e. stateless) compression or inter-packet (i.e. stateful) compression. IPComp can only be used for stateless compression.

Smaller Overhead

In IPComp, the overhead to indicate a compressed packet equals the size of IPComp header, which is 4 bytes. In the present invention, the overhead equals the size of the in-band indication that is an implementation parameter. An indication with size of 2 bytes or even 1 byte can work correctly with good performance.

It is understood that a “magic pattern” is a data structure embodied in an electronically readable medium for storage or generated by an algorithm when needed. This data structure contains a series of data bits of “0” or “1” with an arbitrary size. For example, the size of the data structure can be 8 to 16 bits or smaller or greater.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method of multiplexing a stream of packets for conveying payload data from a first network component to a second network component, the stream of packets including at least one compressed packet comprising a header segment and a data segment following the header segment, wherein the data segment is used to carry at least a portion of the payload data, and the header segment of said packet contains information indicative of an identity of the second network component, said method characterized by
partitioning the data segment of said compressed packet into a first section and a second section, by
providing said portion of the payload data in a compressed form in the first section, and by
providing further information in the second section, the further information indicating that said portion of the payload data is in the compressed form.

2. The method of claim 1, characterized in that
the second section of said compressed packet is located between the first section and the header segment of said compressed packet.

3. The method of claim 1, further characterized by
providing an error check code in the second section for detecting transmission errors in the compressed packet.

4. The method of claim 3, wherein the error check code is a cyclic redundancy check code.

5. The method of claim 1, wherein said further information is provided in a bit pattern.

6. The method of claim 1, wherein said further information is provided in a form of a predetermined bit pattern.

7. The method of claim 6, wherein the predetermined bit pattern is known to the second network component.

8. The method of claim 1, wherein the stream of packets is a transport protocol packet stream.

9. The method of claim 8, wherein the transport protocol is transmission control protocol (TCP).

10. The method of claim 8, wherein the transport protocol is user datagram protocol (UDP).

11. A compression algorithm to be used in a first network component capable of conveying a stream of packets containing payload data to a second network component, the stream of packets including at least one compressed packet comprising a header segment and a data segment following the header segment, wherein the data segment is used to include at least a portion of the payload data, and the header segment of said packet contains information indicative of an identity of the second network component, said compression algorithm characterized by
compressing the portion of the payload data for providing compressed data;
providing the compressed data in a first segment of the data segment of the compressed packet; and
providing further information in a second segment of the data segment of the compressed packet, wherein the further information indicating that the portion of payload data is compressed, and wherein the second section is located between the first section and the header segment of the compressed packet.

12. The algorithm of claim 11, further characterized by
providing an error check code in the second section for detecting transmission errors in the compressed packet.

13. The algorithm of claim 11, further characterized by
determining whether the portion of the payload data is compressible so that said compression is carried out only if the payload data is compressible.

14. The algorithm of claim 11, characterized in that
the further information is provided in a form of a predetermined bit pattern.

15. A decompression algorithm to be used in a network component capable of receiving a stream of packets containing payload data conveyed from another network component, each of the packet containing a header segment and a data segment following the header segment, wherein the data segment is used to include at least a portion of the payload data, and the header segment of said packet contains information indicative of an identity of the second network component, said decompression algorithm characterized by
determining whether the data segment contains further information indicating that the portion of the payload data is compressed; and
decompressed the portion of the payload data based on said determining.

16. The decompression algorithm of claim 15, characterized in that
said further information is provided in a form of a predetermined bit pattern.

17. A network component adapted to transmitting and receiving a stream of packets containing payload data to a second network component, the stream of packets including at least one compressed packet comprising a header segment and a data segment following the header segment, wherein the data segment is used to include at least a portion of the payload data, and the header segment of said packet contains identity information indicative of an identity of the second network component, said network component characterized by
a compressor capable of compressing the portion of the payload data for transmission; and
a decompressor capable decompressing the portion of the payload data in a received stream, wherein
the compressor is adapted to
compressing the portion of the payload data for providing compressed data,
providing the compressed data in a first segment of the data segment of the compressed packet; and
inserting information in a second segment of the data segment of the compressed packet, wherein the information indicating that the portion of payload data is compressed, and wherein the second section is located between the first section and the header segment of the compressed packet, and wherein the decompressor is adapted to
determining whether the data segment contains further information indicating that the portion of the payload data is compressed; and
decompressing the portion of the payload data based on said determining.

18. The network component of claim 17, characterized by a mobile terminal capable of uplink and downlink communications in a telecommunications network, wherein the compressor and the compressor are disposed in the mobile terminal, such that
the compressor compresses the portion of the payload data, providing the compressed data in the data segment and inserting the information when the mobile terminal operates in uplink communications.

19. The network component of claim 18, further characterized in that
the decompressor determines the further information and decompresses the portion of the payload data based on said determining when the mobile terminal operates in downlink communications.

20. A system for compressing and decompressing payload data in a stream of packets conveyed between network components in a communication network, the stream including at least one compressed packet comprising a header segment and a data segment following the header segment, wherein the data segment is used to include at least a portion of the payload data, and the header segment of said packet contains identity information indicative of an identity of a receiving network component, said system characterized by
a compressor capable of compressing the portion of the payload data; and
a decompressor capable decompressing the portion of the payload data, wherein
the compressor is adapted to
compressing the portion of the payload data for providing compressed data,
providing the compressed data in a first segment of the data segment of the compressed packet; and
inserting information in a second segment of the data segment of the compressed packet, indicating that the portion of payload data is compressed, and wherein the second section is located between the first section and the header segment of the compressed packet, and wherein
the decompressor is adapted to
determining whether the data segment contains further information indicating that the portion of the payload data is compressed; and
decompressing the portion of the payload data based on said determining.
